(19) United States
(12) Patent Application Publication
(10) Pub. No.: US 2017/0099648 A1
(43) Pub. Date: Apr. 6, 2017

(54) DEVICE POSITIONING

(71) Applicant: QUALCOMM Incorporated, San Diego, CA (US)

(72) Inventors: Rahul Malik, San Diego, CA (US); Carlos Horacio Aldana, Mountain View, CA (US); Hemanth Sampath, San Diego, CA (US)

(21) Appl. No.: 15/251,987

(22) Filed: Aug. 30, 2016

Related U.S. Application Data
(60) Provisional application No. 62/236,740, filed on Oct. 2, 2015.

(51) Int. Cl. H04W 64/00; H04L 29/12

(52) U.S. Cl. CPC H04W 64/00; H04L 61/6022; H04W 84/12

(57) ABSTRACT

Methods, apparatuses, and systems are described that implement techniques and protocols to enable a first device to send positioning information to a second device. For example, an apparatus device may include a processor configured to generate, at a first device, a data frame including an address field and a data field. The address field includes a particular value indicating that the data field includes positioning information related to a location of the first device. The apparatus also includes a transmitter configured to transmit the data frame to a second device.

### I. CROSS REFERENCE TO RELATED APPLICATIONS

The present application claims the benefit of U.S. Provisional Patent Application No. 62/236,740 (Atty. Dkt. No. 154989P1), entitled “DEVICE POSITIONING,” filed Oct. 2, 2015, which is expressly incorporated by reference herein in its entirety.

### II. FIELD

The present disclosure is generally related to device positioning.

### III. DESCRIPTION OF RELATED ART

The Institute of Electrical and Electronics Engineers (IEEE) has promulgated various industry specifications related to wireless networking, many of which are designated with the “IEEE 802.11” name. Typically, before a specification is drafted, a study group or task group is formed to evaluate the interest and feasibility of particular wireless technology. For example, the “Next Generation Positioning” (NGP) study group is tasked with enhancing accuracy and scalability of device positioning and to adding support for new position techniques. Conventional techniques defined by the IEEE 802.11 standard to determine a position of a first device relative to an associated second device, such as timing measurement and fine timing measurement techniques, can transmit six or more unicast frames per device to determine the position. Using six or more unicast frames per device to determine a device's position increases messaging traffic of a communication channel and reduces available bandwidth of the communication channel for other information.

### IV. SUMMARY

In a particular aspect, an apparatus includes a processor configured to generate, at a first device, a data frame including an address field and a data field. The address field includes a particular value indicating that the data field includes positioning information related to a location of the first device. The apparatus also includes a transmitter configured to transmit the data frame to a second device.

In another particular aspect, a method of communicating positioning information includes generating, at a first device, a data frame including an address field and a data field. The address field includes a particular value indicating that the data field includes positioning information related to a location of the first device. In some implementations, the positioning information may include coordinate data, global positioning system (GPS) data, relative position data (e.g., relative to another device or object), absolute position data, elevation data, or a combination thereof, as illustrative, non-limiting examples. The method further includes transmitting the data frame from the first device to a second device.

In another particular aspect, an apparatus includes means for generating a data frame including an address field and a data field. The address field includes a particular value indicating that the data field includes positioning information related to a location of a first device. The apparatus further includes means for transmitting the data frame to a second device.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of an illustrative aspect of a system that enables a first device to send positioning information to a second device;

FIG. 2 is a block diagram of a first illustrative example of a data frame format configured to include positioning information;

FIG. 3 is a block diagram of a second illustrative example of a data frame format configured to include positioning information;

FIG. 4 is a flow diagram of an illustrative method of operating a device to send positioning information;

FIG. 5 is a flow diagram of an illustrative method of operating a device to receive positioning information; and

FIG. 6 is a diagram of a wireless device that is operable to support various aspects of one or more methods, systems, apparatuses, or computer-readable media disclosed herein.

### VI. DETAILED DESCRIPTION

Particular aspects of the present disclosure are described below with reference to the drawings. In the description, common features are designated by common reference numbers throughout the drawings. As used herein, various terminology is used for the purpose of describing particular implementations and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

The disclosure is related to a signaling structure, such as a data frame format, for a “Next Generation Positioning” (NGP) protocol. The NGP protocol may provide NGP functionality, such as positioning, calibration of signal path differences, etc. For example, the signaling structure for the NGP protocol may enable a first device to send positioning information to a second device as described herein.

The NGP protocol may correspond to a set of media access control (MAC) addresses. The set of MAC addresses may include a set of organizationally unique identifiers (OUIs). For example, the set of MAC addresses may be reserved (e.g., issued) from a pool of Institute of Electrical and Electronics Engineers (IEEE) OUIs. The set of MAC addresses may include a single MAC address or multiple MAC addresses. If the set of MAC addresses includes multiple MAC addresses, each MAC address may correspond to a different device operation, such as a positioning/location determination operation, a channel calibration operation, etc. To illustrate, a first MAC address may correspond to NGP positioning functionality and a second MAC address may correspond to NGP calibration for signal path differences, as illustrative, non-limiting examples.

A particular MAC address (e.g., a particular value) of the set of MAC addresses may be included in a data frame to indicate that the data frame (or data included in the data frame) is to be processed according to the NGP protocol. For example, the particular MAC address may indicate that a data field, such as a payload, of the data frame includes positioning information, such as, positioning information of a device that generated the data frame. In some implementations, the data frame may be a beacon message, a probe message, or a public action frame, such as a public action frame that complies with an IEEE 802.11 standard. In such implementations, a particular MAC address of the set of MAC addresses may be included in a particular field (e.g., a particular address field) of the public action frame, such as a public action frame having a format that complies with the IEEE 802.11 standard. In some implementations, the public action frame may be a vendor specific public action frame.

In other implementations, the data frame may include an EtherType field and a value of the EtherType field indicate a protocol to be used to process data included in a payload field (e.g., a data field). For example, a destination MAC field of an Ethernet frame may include a MAC address from the set of MAC addresses and the value of the EtherType field may indicate that data encapsulated in a payload of the Ethernet Frame is to be processed using the NGP protocol.

A data frame that includes a particular MAC address (e.g., a particular value) of the set of MAC addresses may be generated by a first device and transmitted to the second device. The first device may be associated with or unassociated with the second device. In some implementations, the first device may broadcast (or multicast) the data frame to the second device and the particular MAC address may correspond to a group MAC address. To illustrate, the first device may include an access point (AP) that broadcasts the data frame to the second device, such as a station (STA). A device that receives the data frame may detect the particular MAC address and may determine whether to process the data frame based on the particular MAC address. For example, if the particular MAC address indicates that a data field of a data frame includes NGP positioning information and the device receiving the data frame has determined its own location or position relative to another device or object, the device may determine to not process the data frame.

In some implementations, the second device may include an out of context parameter. When the out of context parameter is set to true, the second device may be enabled to receive and transmit data to unassociated devices of a basic service set (BSS) without performing preliminary authentication and association signaling. For example, the out of context parameter may include a dot11OCBEnabled parameter, such as a dot11OCBEnable parameter that complies with the IEEE 802.11p standard. To illustrate, in IEEE 802.11p, a management information base (MIB) “dot11OCB” is defined into the MAC Layer Management Entity (MLME). Per the IEEE 802.11 standard, when “dot11OCBEnabled” is set to true in a particular device, additional operations or constraints are applied to the device. For example, when “dot11OCBEnabled” is set to true, the second device may be configured in an outside of context of a basic service set (OCB) mode in which the second station is configured to receive message from unassociated devices. Accordingly, when the second device's out of context parameter (e.g., the dot11OCBEnabled parameter) is set to true, the second device may receive a data frame that includes a particular MAC address (of the set of MAC addresses) from an unassociated device, such as the first device. Thus, by the second device setting its out of context parameter to true, the second device may receive data frames (that include positioning information) from other devices that the second device is in an unassociated state with.

The present disclosure thus describes techniques for indicating that a data frame includes data to be processed according to a “Next Generation Positioning” (NGP) protocol. For example, the techniques may enable a first device to send positioning information included in a data frame to a second device. The data frame may include a particular value (e.g., an organizationally unique identifier) that indicates that the data frame includes the positioning information. The second device that receives the data frame may identify the particular value and may selectively process the data frame based on the particular value. For example, the second device may process a portion of the data frame according to the NGP protocol. Additionally, the signaling structure of the NGP protocol may enable a first device to send a data frame corresponding to the NGP protocol associated devices and unassociated devices. For example, the data frame may be broadcast (or multicast) from a first device to one or more associated devices, one or more unassociated devices, or a combination thereof. By broadcasting (or multicasting) the data frame that includes the positioning information, a receiving device may acquire the positioning information without having to perform a time measurement technique that would include multiple unicast messages. By exchanging positioning information between different devices, a particular device that receives the positioning information may determine its location, such as a relative location or an absolute location. For example, the particular device may determine its location using one or more positioning techniques, such as a time measurement technique, a fine time measurement technique, triangulation, a technique defined by a standard (e.g., an IEEE 802.11 standard or a Wi-Fi Alliance standard), or a GPS. The particular device may use its own location in several situations, such as navigation, identifying a closest device to associate with, etc.

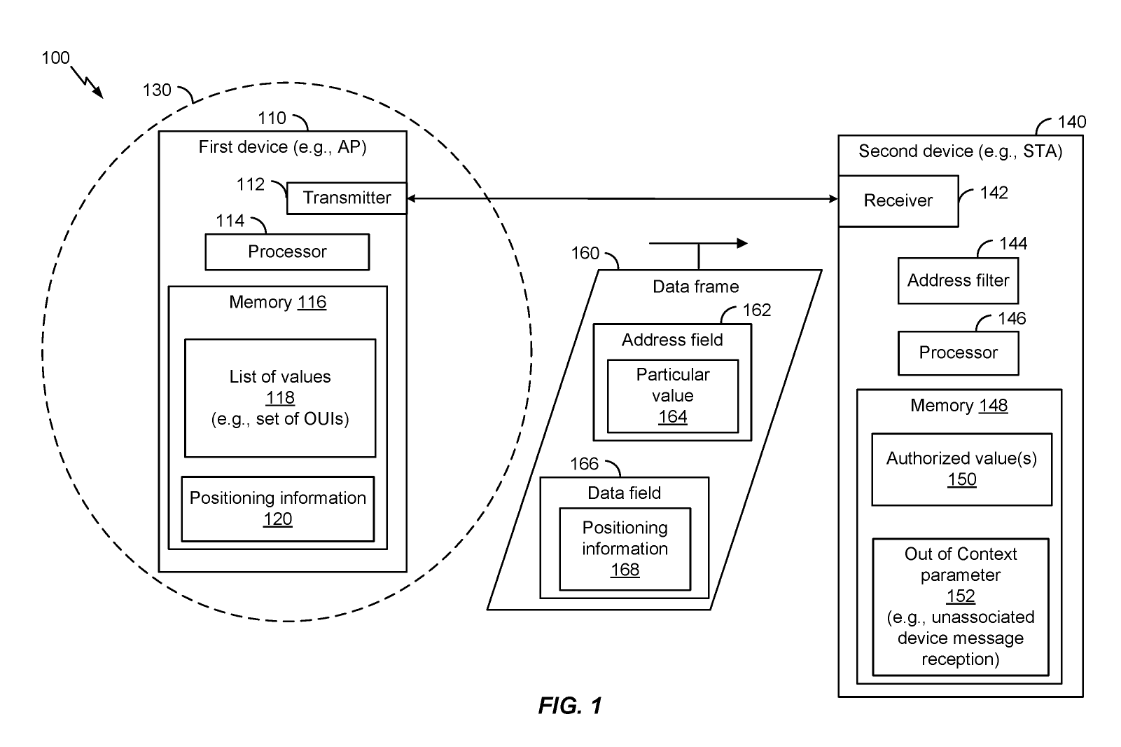

Referring to FIG. 1, a first aspect of a system 100 in which a first device is configured to send positioning information to a second device is shown. The system 100 includes a first device 110 and a second device 140. The first device 110 may include an access point (AP) or a station (STA). The second device 140 may include an AP or a STA. It should be noted that although FIG. 1 depicts two devices, the system 100 may include fewer than or more than two devices. Each of the devices 110, 140 may operate in compliance with a standard, such as an IEEE 802.11 standard (e.g., IEEE 802.11k, IEEE 802.11ai, or both), or a Wi-Fi Alliance standard (e.g., an optimized connectivity experience (OCE) standard, a multi-band operation (MBO) standard, or both), as illustrative, non-limiting examples.

Each of the devices 110, 140 may be an electronic device that is operable to wirelessly communicate and receive data via a wireless network. For example, the first device 110, the second device 140, or both may be a mobile device, an access point, a wireless phone, a personal digital assistant (PDA), a portable computing device, a tablet computing device, a portable media player, a base station, or any combination thereof, as illustrative, non-limiting examples.

In some implementations, the first device 110 may be associated with (e.g., in an associated state with) the second device 140. To illustrate, the first device 110 and the second device 140 may be configured to perform an authentication process, such as a handshake and key exchange process. For example, the first device 110 and the second device 140 may perform an authentication process to establish an authenticated session (e.g., an associated session) between the first device 110 and the second device 140. If an authenticated session is established between the first device 110 and the second device 140, each of the first device 110 and the second device 140 may be considered as associated with (e.g., in an associated state with) the other device. The authenticated session may enable secure (e.g., encrypted) communication between the first device 110 and the second device 140. In other implementations, the first device 110 may be unassociated with the second device 140. If the first device 110 and the second device 140 are in an unassociated state, which may include an unauthenticated state, with each other, the first device 110 and the second device 140 may wirelessly communicate with each other using an unsecured message, such as a probe message, a public action frame, a beacon, or an unencrypted control message, as illustrative, non-limiting examples.

In some implementations, at least one of the devices 110, 140 may be a node of a wireless network. For example, the first device 110 may be an IEEE 802.11 access point that supports its own wireless data network. To illustrate, the first device 110 may support its own network that corresponds to a basic service set (BSS) 130. If the second device 140 is associated with the first device 110, the second device 140 may be included in the BSS 130. Alternatively, if the second device 140 is unassociated with the first device 110, the second device 140 may not be included in the BSS 130.

The first device 110 may be configured to generate a data frame according to a “Next Generation Positioning” (NGP) protocol. The first device 110 may include a transmitter 112, a processor 114, and a memory 116. The memory 116 may include a list of values 118 (e.g., a set of organizationally unique identifiers (OUIs)). Although described herein as a list, the values (e.g., the set of OUIs) may be arranged in a data structure or format other than a list. In some implementations, the list of values 118 may include a set of media access control (MAC) addresses. The list of values 118, such as the set of MAC addresses may be reserved (e.g., issued) from a pool of Institute of Electrical and Electronics Engineers (IEEE) OUIs. The list of values 118 may include a single value, such as a single MAC address, or multiple values, such as multiple MAC addresses. If the list of values 118 includes multiple MAC addresses, each MAC address may correspond to a different NGP functionality. To illustrate, a first MAC address may correspond to NGP positioning functionality in which a position of a particular device is provided to at least one other device. As another example, a second MAC address may correspond to NGP calibration functionality in which a signal path difference may be calibrated between two devices, as illustrative, non-limiting examples.

The memory 116 may further include positioning information 120. The positioning information 120 may indicate a position (e.g., a location) of the first device 110. For example, the positioning information 120 may include position data of the first device 110 and a corresponding device identifier, such as a MAC address, of the first device 110. The position data may include coordinate data, global positioning system (GPS) data, relative position data (e.g., relative to another device or object), absolute position data, elevation data, or a combination thereof, as illustrative, non-limiting examples. In some implementations, the positioning information 120 may have been pre-programmed into the first device 110 by a user of the first device 110 or the first device 110 may have received the positioning information 120 from another device of the system 100 or from a GPS (not shown) of the first device 110. In other implementations, the first device 110 may determine the positioning information 120 using one or more positioning techniques, such as a time measurement technique, a fine time measurement technique, triangulation, or a technique defined by a standard (e.g., an IEEE 802.11 standard or a Wi-Fi Alliance standard). To illustrate, the IEEE 802.11 standard may define a NGP positioning technique that may be used by the first device 110 to generate the positioning data. Additionally, or alternatively, the positioning information 120 may indicate a position (e.g., a location) of another device, such as a third device (not shown) of the system 100. The third device may include an access point (AP) or a station (STA). The third device may be associated with or unassociated with the first device 110.

The processor 114 may be configured to generate a data frame, such as a data frame 160, as described herein. The data frame 160 may include an address filed 162 and a data field 166. The address field 162 may include a particular value 164, such as one of the values from the list of values 118. The data field 166 may include positioning information 168. The positioning information 168 may include at least a portion of the positioning information 120, such as a position of the first device 110. The particular value 164 included in the address filed 162 may indicate that the data field 166 includes the positioning information 168. The data frame 160, or a portion thereof, may comply with a NGP protocol. For example, the positioning information 168 may be arranged (e.g., organized or formatted) in the data field 166 according to the NGP protocol.

The transmitter 112 may be configured to transmit (e.g., wirelessly transmit) data from the first device 110 to another device, such as the second device 140. For example, the transmitter 112 may be configured to transmit a data unicast message or a multicast message. In a particular implementation, the first device 110 is a mobile device into which the processor 114 and the transmitter 112 are integrated. In another particular implementation, the first device 110 is an access point into which the processor 114 and the transmitter are integrated. In another particular implementation, the first device 110 is a base station into which the processor 114 and the transmitter are integrated.

The second device 140 is configured to receive and process a data frame, such as the data frame 160, according to a NGP protocol. The second device 140 may include a receiver 142, an address filter 144, a processor 146, and a memory 148. The receiver 142 may be configured to receive the data frame 160.

The address filter 144 may be configured to determine whether to provide a received data frame to the processor 146. For example, the address filter 144 may be configured to identify the particular value 164 of the address field 162 of the data frame 160. The address filter 144 may compare the particular value 164 to a set of authorized values 150. If the address filter 144 determines that the particular value 164 matches a value of the set of authorized values 150, the data frame 160 may be provided to the processor 146. Alternatively, if the address filter 144 determines that the particular value 164 does not match any value of the set of authorized values 150, the data frame 160 may be discarded and may not be provided to the processor 146. The address filter 144 may include hardware, software, or a combination thereof.

The processor 146 is configured to process at least a portion of the data frame 160 according to the NGP protocol. For example, the processor 146 may process the data field 166 of the data frame 160 according to the NGP protocol. To illustrate, if the particular value 164 included in the address field 162 indicates that the data field includes the positioning information 168, the processor 146 may store the positioning information 168. The processor 146 may further be configured to determine a position (e.g., a fixed position) of the second device 140. For example, the processor 146 may be configured to implement a triangulation technique that uses positioning information of other devices in the system 100 to determine the position of the second device 140.

The memory 148 may include a set of authorized values 150 and an out of context parameter 152. The set of authorized values 150 may include one or more authorized OUIs, such as one or more authorized MAC addresses, that may be compared to the particular value 164 by the address filter 144. In some implementations, the set of authorized values 150 may include a null set (e.g., the set of authorized values 150 may not include any authorized values).

The out of context parameter 152 may indicate whether the second device 140 is be configured in an outside of context of a basic service set (OCB) mode in which the second device 140 is enabled to receive and transmit data to an unassociated device of a basic service set (BSS) without performing preliminary authentication and association signaling with the device. For example, if a value of the out of context parameter 152 (e.g., dot11OCBActivate parameter or dot11OCBEnabled parameter) is set to true, such as a logical 1 value, the second device may be configured to receive and transmit data with an unassociated device. According, when the second device's out of context parameter 152 is true, the second device 140 may receive the data frame 160 from the first device 110 even if the first device 110 and the second device 140 are unassociated. Alternatively, if the value of the out of context parameter 152 is set to false, such as a logical 0 value, the second device 140 may not be configured to receive and transmit data with an unassociated device. In a particular implementation, the out of context parameter complies with one or more standards, such as an IEEE 802.11p standard, as an illustrative, non-limiting example.

During operation of the system 100, the first device 110 may determine to transmit positioning information 120 to another device, such as the second device 140. The first device 110 may select the particular value 164 from the list of values 118. For example, the particular value 164 may include a first MAC address (e.g., a first OUI) that indicates that the data field 166 includes positioning information. As another example, the particular value may include a second MAC address (e.g., a second OUI) that indicates that the data field 166 includes calibration information. To illustrate, the calibration information may include information, such as a transmit power or gain value, of a transmitter array of the first device 110 to enable another device (e.g., the second device 140) to estimate an angle of departure. The first device 110 may generate the data frame 160 and may include the particular value 164 in the address field 162 of the data frame 160 and may include the positioning information 168 in the data field 166. The first device 110 may transmit the data frame 160 to the second device 140 as a unicast message or as a multicast message.

The second device 140 may receive the data frame 160. In some implementations, the second device 140 may be unassociated with the first device 110 when the second device 140 receives the data frame 160. The address filter 144 may determine whether to provide the data frame 160 to the processor 146. For example, the address filter 144 may compare the particular value 164 of the address field 162 to the set of authorized values 150. If the particular value 164 matches one of the set of authorized values 150 the data frame 160 may be provided to the processor 146 and the processor 146 may retrieve the positioning information 168.

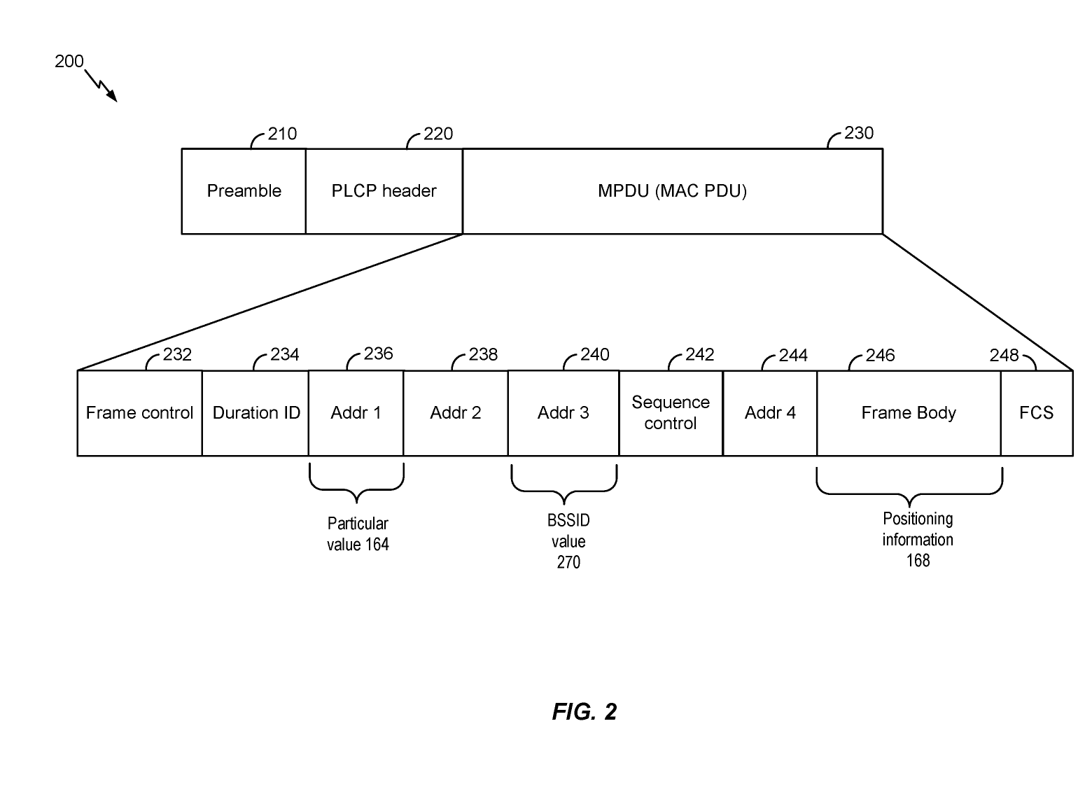

In some implementations, the data frame 160 may be a public action frame, as described with reference to FIG. 2. For example, the data frame 160 may include a public action frame that complies with an IEEE 802.11 standard. In such implementations, the particular value 164 (e.g., a particular MAC address) may be included in an address 1 field of the public action frame.

In some implementations, the first device 110 may generate the data frame 160 to be transmitted to another device included in the same BSS (e.g., the BSS 130) as the first device 110, such as another device that is associated with the first device 110. In such implementations, the first device 110 may populate another field of the data frame 160 with a BSS identifier (ID) of the BSS 130. As an illustrative, non-limiting example, the other field may include an address 3 field of the public action frame that is populated with the BSSID of the BSS 130. In other implementations, the first device may generate the data frame 160 to be transmitted to devices that are unassociated with the first device 110. In such implementations, the first device 110 may populate the other field of the data frame 160 with a wild-card BSSID, such all logical 1's. As an illustrative, non-limiting example, the other field may include an address 3 field of the public action frame that is populated with the wild-card BSSID.

The second device 140 that receives the data frame 160 may determine whether the other field of the data frame 160 includes the BSSID or the wild-card BSSID. For example, the address filter 144 may determine whether a value of the other field matches the wild-card BSSID. If the value of the other field matches the wild-card BSSID, the data frame 160 may be provided to the processor 146. In some implementations, the data frame 160 may be provided to the processor 146 if the other field matches the wild-card BSSID and the particular value 164 of the address field 162 matches one of the authorized values 150. If the value of the other field does not match the wild-card BSSID, the address filter 144 may determine whether the value of the other field matches a second BSSID of BSS that the second device 140 is associated with. If the value of the other field matches the second BSSID, the data frame 160 may be provided to the processor 146. In some implementations, the data frame 160 may be provided to the processor 146 if the other field matches the second BSSID and the particular value 164 of the address field 162 matches one of the authorized values 150. Alternatively, if the value of the other field does not match the second BSSID, the data frame 160 may not be provided to the processor 146 (e.g., the data frame 160 may be discarded without further processing).

In some implementations, the data frame 160 may include a vendor specific public action frame. If the data frame 160 includes the vendor specific public action frame, the vendor specific public action frame may have a category value (e.g., category type field) of 9 (e.g., value=9). In such implementations, devices (e.g., the first device 110 and the second device 140) manufactured by the same vendor, distributed by the same vendor, or operated according to software provided by the same vendor, may wirelessly communicate when not associated with each other. If the devices are from different vendors, distributed by different vendors, or operated according to software provided from different vendors, a receiving device that receives the data frame 160 may ignore the vendor specific public action frame or may respond to the vendor specific public action frame with a response message that includes an asserted “incapable” flag or “refused” flag in the response message.

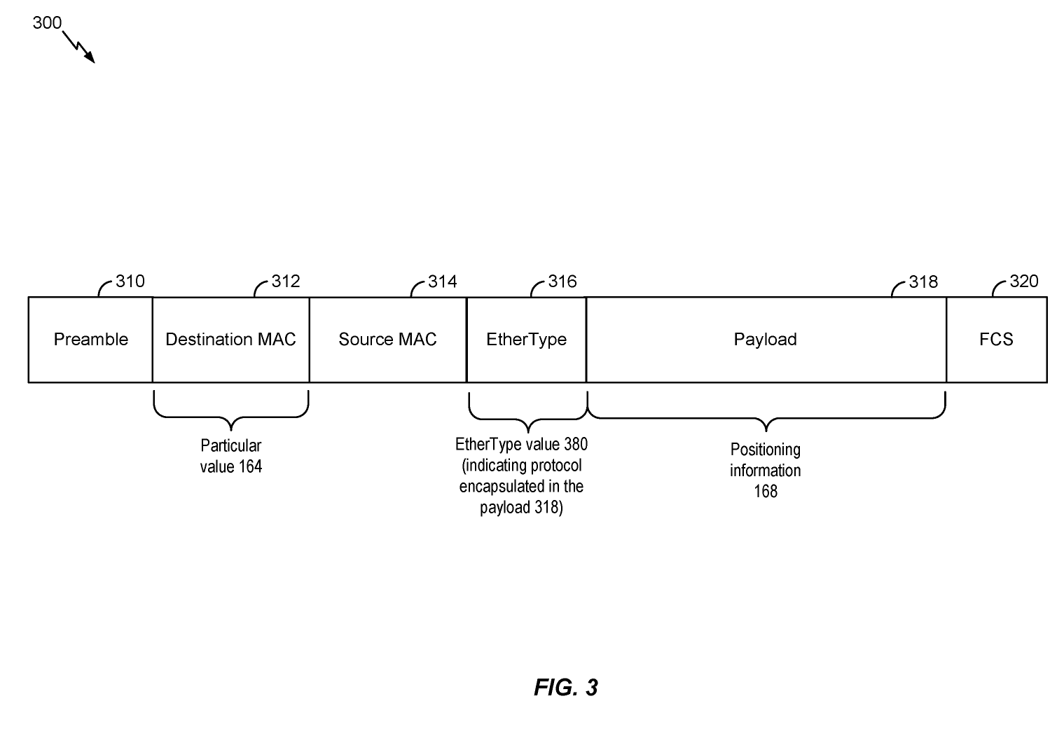

In other implementations, the data frame 160 may include an Ethernet frame having an EtherType field, as describe with reference to FIG. 3. A value of the EtherType field may indicate which protocol is encapsulated in a payload of the Ethernet Frame. For example, the value of the EtherType field may indicate that the NGP protocol is encapsulated in the payload (e.g., a data field) of the Ethernet frame.

In some implementations, the second device 140 may be configured to update the set of authorized values 150 during operation of the second device 140. For example, if the second device 140 has determined a position (e.g., a location) of the second device 140, the second device 140 may remove a value corresponding to positioning information from the set of authorized values 150. By removing the value corresponding to positioning information, data frames that include the value corresponding to positioning information may not be provided to the processor 146 (e.g., the address filter 144 may filter out data frames that include the value corresponding to positioning information).

Although operations of the system 100 have been described with reference to the first device 110 or the second device 140, it should be noted that the first device 110 and the second device 140 may each be configured to perform operations described with reference to another device. For example, the first device 110 may be configured to receive a data frame from another device that is associated with or unassociated with the first device 110. To illustrate, the first device 110 may include a receiver (not shown). The receiver of the first device may be configured to operate as described with reference to the receiver 142 of the second device. The receiver of the first device 110 may be configured to receive a second data frame from a third device (not shown). The second data frame includes a second address field and a second data field. The second address field includes a second particular value indicating that the second data field includes second positioning information related to a second location of the third device. The processor 114 of the first device 110 may further be configured to process the second positioning information based on the second particular value. In some implementations, the second device 140 and the third device are the same device. Additionally, or alternatively, the first device 110 may include address filter hardware (not shown) configured to detect the second particular value included in the second data frame. For example, the address filter hardware of the first device 110 may be configured to operate as described with reference to the address filter 144 of the second device 140. The address filter hardware of the first device 110 may further be configured to perform a comparison based on the second particular value and an authorized value. The second positioning information may be selectively processed by the processor 114 based on the comparison.

By including the particular value 164 (e.g., an organizationally unique identifier) in the data frame 160, the first device 110 may indicate that the data field 166 includes the positioning information 168. The data frame 160 including the particular value 164 may be transmitted to one or more devices that are associated with the first device 110, one or more devices that are unassociated with the first device 110, or both. In some implementations, the first device 110 may multicast the data frame 160 to one or more devices. By multicasting (or broadcasting) the data frame 160 that includes the positioning information 168, a receiving device may acquire the positioning information 168 without having to perform a time measurement technique that would include multiple unicast messages.

Referring to FIG. 2, a first illustrative example of a data frame format configured to include positioning information is shown and designated 200. For example, the data frame format 200 may include or correspond to the data frame 160 of FIG. 1. The data frame format 200 may correspond to a public action frame format, such as a public action frame that complies with an IEEE 802.11 standard.

The data frame format 200 may include multiple fields. To illustrate, the data frame format 200 includes a preamble field 210, a physical layer convergence protocol (PLCP) header field 220, and a MAC protocol data unit (MPDU) field 230. The MPDU field 230 may include multiple subfields. To illustrate, the MPDU field 230 may include a frame control field 232, a duration ID field 234, an address 1 field 126, an address 2 field 238, an address 3 field 240, a se2qeunce control field 242, an address 4 field, a frame body field 246 (e.g., a data field), and a frame check sequence (FCS) field 248.

The address 1 field 236 may include or correspond to the address field 162 of the data frame 160 of FIG. 1. The address 1 field 236 may be configured to have a particular value, such as the particular value 164 of FIG. 1. Alternatively, in other implementations, the particular value 164 may be included in the address 2 field 238, the address 3 field 240, the address 4 field 244, or another field or another sub-field of the data frame format 200. The frame body field 246 may include or correspond to the data field 166 of the data frame 160 of FIG. 1. In some implementations, the address 3 field 240 may include a BSSID value 270. For example, the BSSID value 270 may correspond to a BSS of a device, such as the first device 110 of FIG. 1, that generates a data frame according to the data frame format 200. As another example, the BSSID value 270 may include a wild-card BSSID value. Although the BSSID value 270 is described as being included in the address 3 field 240, in other implementations, the BSSID value 270 may be include another field (or sub-field) of the data frame format 200. For example, the BSSID value 270 may be include in the address 1 field 236, the address 2 field 238, or the address 3 field 240, as illustrative, non-limiting examples.

Although the data frame format 200 is described as including certain fields and sub-fields, in other implementations, the data frame format 200 may include one or more fields, one or more sub-fields, or a combination thereof, in addition to the fields 210-230 and the sub-fields 232-248 described with reference to FIG. 2. For example, in some implementations, the data frame format 200 may correspond to a vendor specific public action frame and may include a category type field, such as a category type sub-field of the MPDU field 230. Additionally, or alternatively, in other implementations, one or more of the fields 210-230, one or more of the sub-fields 232-248, or a combination thereof, of the data frame format 200 described with reference to FIG. 2 may be omitted from the data frame format 200.

Referring to FIG. 3, another illustrative example of a data frame format configured to include positioning information is shown and designated 300. For example, the data frame format 300 may include or correspond to the data frame 160 of FIG. 1. The data frame format 300 may correspond to an Ethernet frame format that complies with an IEEE 802.3 standard.

The data frame format 300 may include multiple fields. To illustrate, the data frame format 300 includes a preamble field 310, a destination MAC field 312, a source MAC field 314, an EtherType field 316, a payload field 318, and a FCS field 320.

The destination MAC field 312 may include or correspond to the address field 162 of the data frame 160 of FIG. 1. The destination MAC field 312 may be configured to have a particular value, such as the particular value 164 of FIG. 1. Alternatively, in other implementations, the particular value 164 may be included in the source MAC field 314, or another field of the data frame format 300. The payload field 318 may include or correspond to the data field 166 of the data frame 160 of FIG. 1. In some implementations, the source MAC field 314 (or the destination MAC field 312) may include a BSSID value, such as the BSSID value 270 of FIG. 2. The EtherType field 316 includes an EtherType value 380 that indicates a protocol encapsulated in the payload field 318.

Although the data frame format 300 is described as including certain fields, in other implementations, the data frame format 300 may include one or more fields in addition to the fields 312-320 described with reference to FIG. 3. Additionally, or alternatively, in other implementations, one or more of the fields 312-320 of the data frame format 300 described with reference to FIG. 3 may be omitted from the data frame format 300.

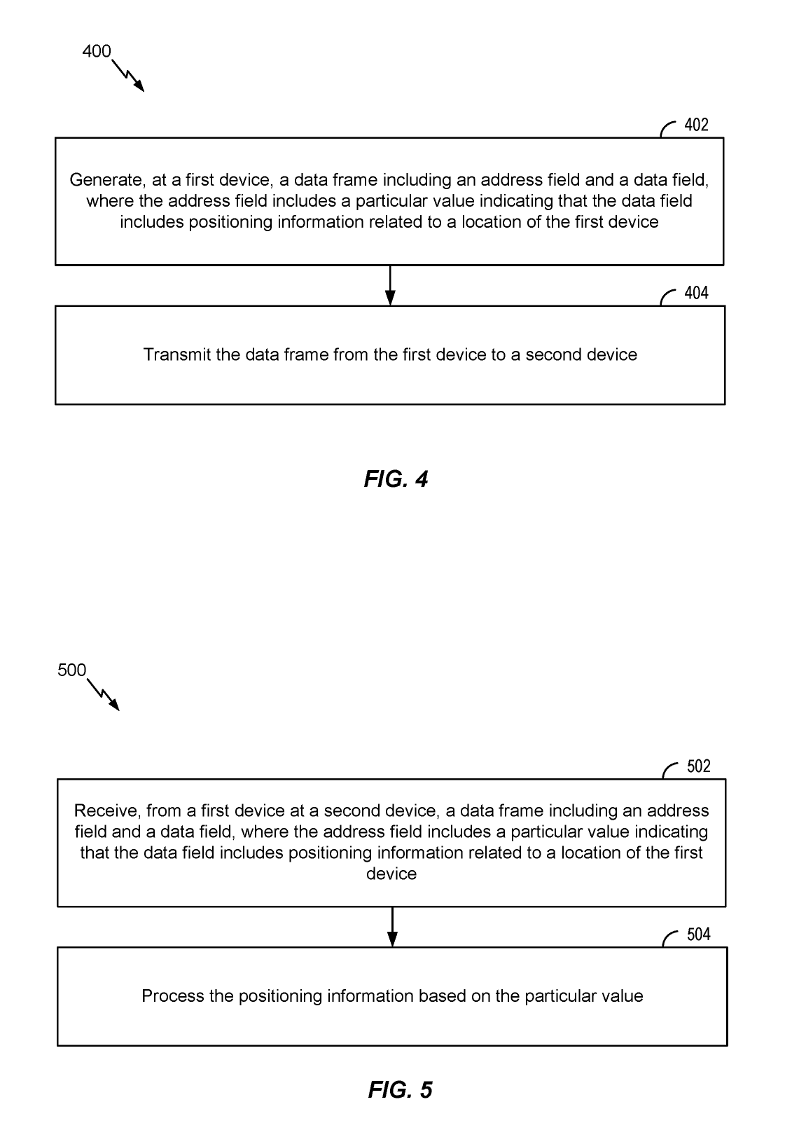

Referring to FIG. 4, an illustrative method 400 of operating a device for communicating positioning information is described. The method 400 may be performed by the first device 110 or the second device 140 of FIG. 1.

The method 400 includes generating, at a first device, a data frame including an address field and a data field, where the address field includes a particular value indicating that the data field includes positioning information related to a location of the first device, at 402. For example, the data frame may include or correspond to the data frame 160 of FIG. 1. The data frame complies with an Institute of Electrical and Electronics Engineers (IEEE) 802.11 standard, an IEEE 802.3 standard, a Wi-Fi Alliance standard, or another standard, as illustrative, non-limiting examples. In some implementations, the data frame may have a data frame format, such as the data frame format 200 of FIG. 2 or the data frame format 300 of FIG. 3.

The particular value may include an organizationally unique identifier (OUI). For example, the particular value may include a particular media access control (MAC) address. In some implementations, the positioning information may include the location of the first device, a device identifier of the first device, or a combination thereof. Additionally, or alternatively, the positioning information may include a second location of a third device, a second device identifier of the third device, or a combination thereof. The first device and the third device may be included in the same BSS or in different BSSs. The third device may include an access point or a station.

The method 400 further includes transmitting the data frame from the first device to the second device, at 404. Transmitting the data frame may include broadcasting the data frame. In some implementations, the first device may include an access point and the second device may include a station. The first device may be in an unassociated state with the second device.

In some implementations, the method 400 may include receiving, from a third device at the first device, a second data frame including a second address field and a second data field. The second address field includes a second particular value indicating that the second data field includes second positioning information related to a second location of the third device. The method 400 may also include processing the positioning information based on the particular value. The second data frame may be received prior to or subsequent to transmitting the data frame to the second device. In some implementations, the second device and the third device are the same device. The method 400 may further include setting an out of context parameter, such as an out of context parameter that complies with an Institute of Electrical and Electronics Engineers (IEEE) 802.11p standard, of the first device to true. The second data frame may be received when the out of context parameter is set to true. In some implementations, the second data frame may also include a third address field that includes a basic service set identifier (BSSID) value. The third address field may include an address 3 field of a public action frame that complies with an Institute of Electrical and Electronics Engineers (IEEE) 802.11 standard. The method 400 may include identifying the BSSID value of the second data frame.

In some implementations, prior to generating the data frame, the method 400 may include identifying the particular value corresponding to the positioning information from a list of values. For example, the list of values may include or correspond to the list of values 118 of FIG. 1. The list of values includes at least the particular value and a second particular value. The second particular value corresponds to calibration information corresponding to calibration of signal path differences at the second device.

In some implementations, the data frame includes a public action frame. When the data frame includes a public action frame, the address field may correspond to an address 1 field of the public action frame. In a particular implementation, the public action frame includes a vendor specific public action frame.

In a particular implementation, the data frame includes a second address field that includes a basic service set identifier (BSSID) value. To illustrate, the second address field may include an address 3 field of a public action frame. In some implementations, the BSSID value may correspond to a basic service set (BSS) that includes the first device or both the first device and the second device. In other implementations, the BSSID value may include a wild-card BSSID value, such as an all l's value.

In another particular implementation, the data frame includes an EtherType field. A value of the EtherType field may indicate a protocol corresponding to the data field. In some implementations, the data frame may include an Ethernet frame, such as an Ethernet frame that complies with an IEEE 802.3 standard.

The method 400 may enable the first device to provide positioning information to one or more devices. For example, the first device may multicast the data frame to an unassociated device to provide the positioning information, such as a location of the first device, to the second device.

Referring to FIG. 5, an illustrative method of operating a device to receive positioning information is described and designated 500. The method 500 may be performed by the first device 110 or the second device 140 of FIG. 1.

The method 500 includes receiving, from a first device at a second device, a data frame including an address field and a data field, where the address field includes a particular value indicating that the data field includes positioning information related to a location of the first device, at 502. For example, the data frame may include or correspond to the data frame 160 of FIG. 1. The data frame complies with an Institute of Electrical and Electronics Engineers (IEEE) 802.11 standard, an IEEE 802.3 standard, a Wi-Fi Alliance standard, or another standard. In some implementations, the second device may in an unassociated state with the first device. To illustrate, the second device may be unassociated with the first device when the second device receives the data frame.

The method 500 further includes processing the positioning information based on the particular value, at 504. In some implementations, the method 500 may selectively process the positioning information based on the particular value.

In some implementations, the second device may include address filter hardware, such as the address filter 144 of FIG. 1. The address filter hardware may be configured to detect the particular value included in the data frame and to compare the particular value to an authorized value, such as an authorized value included in the set of authorized values 150 of FIG. 1. A processor, such as the processor 146 of FIG. 1, of the second device may be configured to receive the positioning information of the data frame in response to the particular value matching the authorized value. Alternatively, in response to the particular value being distinct from the authorized value, the data frame may be discarded (e.g., not provided to the processor).

In some implementations, the method 500 may include setting an out of context parameter of the second device to true. The data frame may be received at the second device when the out of context parameter is set to (e.g., has the value of) true.

In some implementations, the data frame may include a second address field that includes a basic service set identifier (BSSID) value. In such implementations, the method 500 may further include identifying the BSSID value of the data frame. In some implementations, the BSSID value may correspond to a basic service set (BSS) that includes the first device or both the first device and the second device. In other implementations, the BSSID value may comprise a wild-card BSSID value.

The method 500 may enable the second device to receive the data frame and to process the data frame to retrieve the positioning information. In some implementations, the second device may selectively process the data frame based on the particular value included in the data frame.

The process shown in the method 400 of FIG. 4, the method 500 of FIG. 5, or both may be controlled by a processing unit such as a central processing unit (CPU), a controller, a field-programmable gate array (FPGA) device, an application-specific integrated circuit (ASIC), another hardware device, firmware device, or any combination thereof. As an example, the method 400 of FIG. 4, the method 500 of FIG. 5, or both can be performed by one or more processors that execute instructions to generate or process a data frame, such as the data frame 160 of FIG. 1. In some implementations one or more portions of the method 400 of FIG. 4 may be combined with one or more portions of the method 500 of FIG. 5.

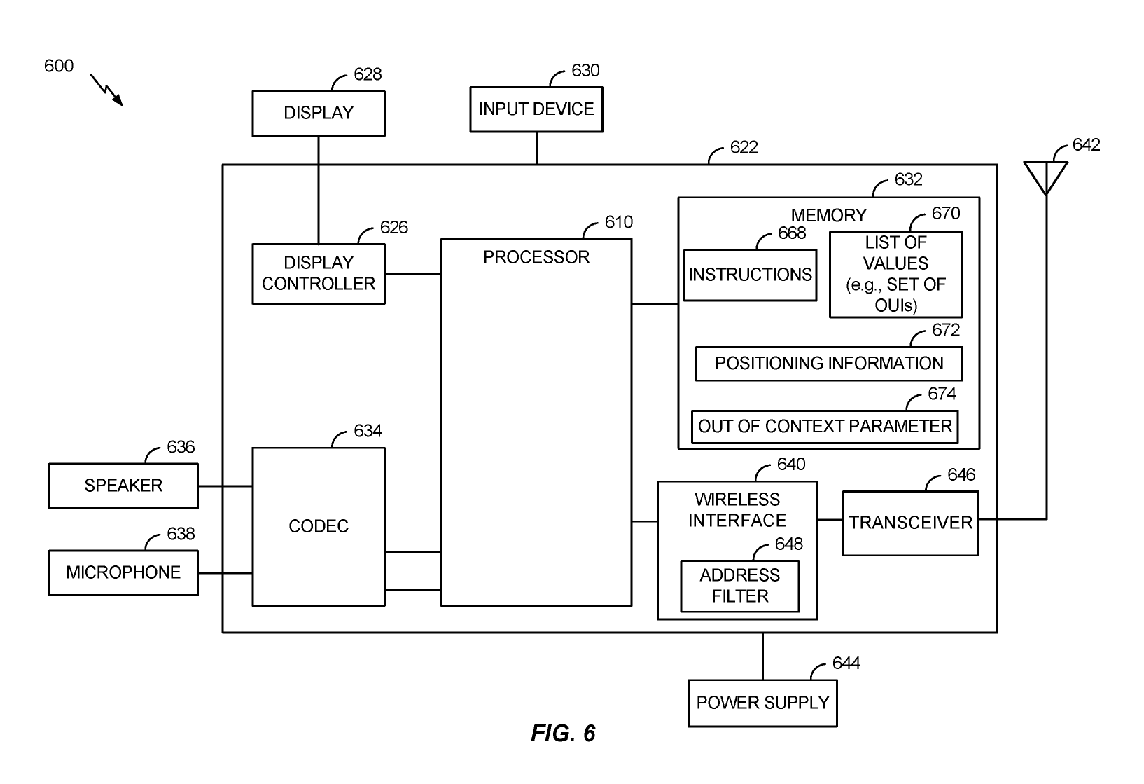

Referring to FIG. 6, a block diagram of a particular illustrative wireless communication device is depicted and generally designated 600. The device 600 includes a processor 610, such as a digital signal processor, coupled to a memory 632. In an illustrative example, the device 600, or components thereof, may include, or be included in, the first device 110, the second device 140 of FIG. 1, a mobile device, an access point, a base station, or components thereof.

Memory 632, such as a non-transitory computer readable medium, may include a list of values 670 (e.g., a set of OUIs), positioning information 672, an out of context parameter 674, and instructions 668. The instructions may be executable by the processor 610. The list of values 670 may include or correspond to the list of values 118, the set of authorized values 150, or a combination thereof, of FIG. 1. The positioning information 672 may include or correspond to the positioning information 120 or the positioning information 168 of FIG. 1. The out of context parameter 674 may include or correspond to the out of context parameter 152 of FIG. 1.

The processor 610 may be configured to execute software (e.g., a program of instructions 668) stored in the memory 632, such as a non-transitory computer readable device. Additionally, or alternatively, the processor 610 may be configured to implement instructions stored in a memory of a wireless interface 640 (e.g., an IEEE 802.11 wireless interface, a Wi-Fi Alliance standard compliant interface, or both). In a particular implementation, the processor 610 is configured to operate in accordance with one or more of the methods of FIGS. 4-5.

To illustrate, the processor 610 may be configured to execute the instructions 668 that cause the processor 610 to generate a data frame including an address field and a data field. The address field includes a particular value that indicates that the data field includes positioning information related to a location of a first device. The processor 610 may also execute the instructions 668 to cause the processor 610 to initiate transmission the data frame to a second device.

As another example, the processor 610 may be configured to execute the instructions 668 that cause the processor 610 to identify a particular value included in a data frame received from a first device. The data frame may include an address field and a data field. The address field includes the particular value indicating that the data field includes positioning information related to a location of the first device. The processor 610 may also execute the instructions 668 to cause the processor to process the positioning information based on the particular value.

The wireless interface 640 may be coupled to the processor 610 and to an antenna 642. For example, the wireless interface 640 may be coupled to the antenna 642 via a transceiver 646, such that wireless data received via the antenna 642 and may be provided to the processor 610. The wireless interface 640 may include an address filter 648. The address filter 648 may include or correspond to the address filter 144 of FIG. 1. The transceiver 646 may include a transmitter, a receiver, or a combination thereof. The transceiver 646 may be configured to wirelessly communicate (e.g., transmit or receive) data, such as a data frame. For example, the processor 610 may be configured to initiate transmission of the data frame 160 of FIG. 1 by the transceiver 646 to an associated or unassociated device.

A coder/decoder (CODEC) 634 can also be coupled to the processor 610. A speaker 636 and a microphone 638 can be coupled to the CODEC 634. A display controller 626 can be coupled to the processor 610 and to a display device 628. In a particular implementation, the processor 610, the display controller 626, the memory 632, the CODEC 634, and the wireless interface 640 are included in a system-in-package or system-on-chip device 622. In some implementations, an input device 630 and a power supply 644 are coupled to the system-on-chip device 622. Moreover, as illustrated in FIG. 6, the display device 628, the input device 630, the speaker 636, the microphone 638, the antenna 642, and the power supply 644 may be external to the system-on-chip device 622. However, each of the display device 628, the input device 630, the speaker 636, the microphone 638, the antenna 642, and the power supply 644 can be coupled to at least one component of the system-on-chip device 622, such as an interface or a controller.

In conjunction with the described aspects, an apparatus includes means for generating a data frame including an address field and a data field. The address field includes a particular value indicating that the data field includes positioning information related to a location of a first device. For example, the means for generating may include the first device 110, the processor 114, the second device 140, the processor 146 of FIG. 1, the processor 610 programmed to execute the instructions 668, the wireless communication device 600 of FIG. 6, another device, circuit, module, or other instructions to generate the data frame, or any combination thereof.

The first apparatus also includes means for transmitting the data frame to a second device. For example, the means for transmitting may include the first device 110, the transmitter 112, the second device 140 of FIG. 1, the wireless interface 640, the transceiver 646, the antenna 642, the wireless communication device 600 of FIG. 6, another device, circuit, module, or other instructions to transmit the data frame, or any combination thereof.

The first apparatus may include means for receiving a second data frame including a second address field and a second data field from a third device. The third device and the second device may be the same device or different devices. The second address field includes a second particular value indicating that the second data field includes second positioning information related to a second location of the third device. For example, the means for receiving may include the first device 110, the second device 140, the receiver 142 of FIG. 1, the wireless interface 640, the transceiver 646, the antenna 642, the wireless communication device 600 of FIG. 6, another device, circuit, module, or other instructions to receive the data frame, or any combination thereof.

The first apparatus may also include means for processing the second positioning information based on the second particular value. For example, the means for processing the second positioning information may include the first device 110, the processor 114, the second device 140, the processor 146, the address filter 144 of FIG. 1, the processor 610 programmed to execute the instructions 668, the address filter 648, the wireless interface 640, the transceiver 646, the wireless communication device 600 of FIG. 6, another device, circuit, module, or other instructions to process the positioning information, or any combination thereof.

In a particular implementation, the wireless communication device is a base station. The base station may be part of a wireless communication system. The wireless communication system may include multiple base stations and multiple wireless devices. The wireless communication system may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1×, Evolution-Data Optimized (EVDO), Time Division Synchronous CDMA (TD-SCDMA), or some other version of CDMA.

Various functions may be performed by one or more components of the base station, such as sending and receiving data, such as the data frame 160 of FIG. 1. The one or more components of the base station may include a processor (e.g., a CPU), a transcoder, a memory, a network connection, a media gateway, a demodulator, a transmission data processor, a receiver data processor, a transmission multiple input-multiple output (MIMO) processor, transmitters and receivers (e.g., transceivers), an array of antennas, or a combination thereof.

During operation of a base station, one or more antennas of the base station may receive a data stream from a wireless device. A transceiver may receive the data stream from the one or more antennas and may provide the data stream to the demodulator. The demodulator may demodulate modulated signals of the data stream and provide demodulated data to the receiver data processor. The receiver data processor may extract audio data from the demodulated data and provide the extracted audio data to the processor.

The processor may provide the audio data to the transcoder for transcoding. The decoder of the transcoder may decode the audio data from a first format into decoded audio data and the encoder may encode the decoded audio data into a second format. In some implementations, the encoder may encode the audio data using a higher data rate (e.g., upconvert) or a lower data rate (e.g., downconvert) than received from the wireless device. In other implementations the audio data may not be transcoded. Transcoding operations (e.g., decoding and encoding) may be performed by multiple components of the base station. For example, decoding may be performed by the receiver data processor and encoding may be performed by the transmission data processor. In other implementations, the processor may provide the audio data to the media gateway for conversion to another transmission protocol, coding scheme, or both. The media gateway may provide the converted data to another base station or core network via the network connection.

Although one or more of FIGS. 1-6 may illustrate systems, apparatuses, or methods according to the teachings of the disclosure, the disclosure is not limited to these illustrated systems, apparatuses, or methods. One or more functions or components of any of FIGS. 1-6 as illustrated or described herein may be combined with one or more other portions of another of FIGS. 1-6. Accordingly, no single aspect described herein should be construed as limiting and aspects of the disclosure may be suitably combined without departing form the teachings of the disclosure.

Those of skill would further appreciate that the various illustrative logical blocks, configurations, modules, circuits, and algorithm steps described in connection with the aspects disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (e.g., non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. An apparatus comprising:
a processor configured to generate, at a first device, a data frame including an address field and a data field, wherein the address field includes a particular value indicating that the data field includes positioning information related to a location of the first device; and
a transmitter configured to transmit the data frame to a second device.

2. The apparatus of claim 1, wherein the particular value comprises a particular media access control (MAC) address or an organizationally unique identifier (OUI).

3. The apparatus of claim 1, wherein the data frame comprises a public action frame, and wherein the address field is an address 1 field of the public action frame that complies with an Institute of Electrical and Electronics Engineers (IEEE) 802.11 standard.

4. The apparatus of claim 1 wherein the data frame comprises a public action frame, and wherein the public action frame comprises a vendor specific public action frame.

5. The apparatus of claim 1, wherein the processor and the transmitter are integrated into a mobile device.

6. The apparatus of claim 1, wherein the processor and the transmitter are integrated into a base station.

7. The apparatus of claim 1, further comprising a receiver configured to receive a second data frame from a third device, the second data frame including a second address field and a second data field, wherein the second address field includes a second particular value indicating that the second data field includes second positioning information related to a second location of the third device, and wherein the processor is further configured to process the second positioning information based on the second particular value.

8. The apparatus of claim 7, further comprising address filter hardware configured to detect the second particular value included in the second data frame, wherein the address filter hardware is further configured to perform a comparison based on the second particular value and an authorized value, and wherein the second positioning information is selectively processed based on the comparison.

9. A method of communicating positioning information, the method comprising:
generating, at a first device, a data frame including an address field and a data field, wherein the address field includes a particular value indicating that the data field includes the positioning information related to a location of the first device; and
transmitting the data frame from the first device to a second device.

10. The method of claim 9, wherein the first device comprises an access point and the second device comprises a station, wherein the first device is in an unassociated state with the second device, wherein the data frame complies with an Institute of Electrical and Electronics Engineers (IEEE) 802.11 standard, a Wi-Fi Alliance standard, or both.

11. The method of claim 9, further comprising, prior to generating the data frame, identifying the particular value corresponding to the positioning information from a list of values, wherein the list of values includes at least the particular value and a second particular value, and wherein the second particular value corresponds to calibration information corresponding to calibration of signal path differences at the second device.

12. The method of claim 9, wherein transmitting the data frame comprises broadcasting the data frame, wherein the positioning information comprises the location of the first device and a device identifier of the first device, and wherein the positioning information comprises a second location of a third device.

13. The method of claim 9, wherein the data frame comprises a second address field that includes a basic service set identifier (BSSID) value, wherein the BSSID value corresponds to a basic service set (BSS) that includes the first device, and wherein the first device and the second device are included in the BSS.

14. The method of claim 9, wherein the data frame comprises a second address field that includes a basic service set identifier (BSSID) value, and wherein the BSSID value comprises a wild-card BSSID value.

15. The method of claim 9, wherein the data frame includes an EtherType field, and wherein a value of the EtherType field indicates a protocol corresponding to the data field.

16. The method of claim 9, further comprising:
receiving, from a third device at the first device, a second data frame including a second address field and a second data field, wherein the second address field includes a second particular value indicating that the second data field includes second positioning information related to a second location of the third device; and
processing the second positioning information based on the second particular value.

17. The method of claim 16, further comprising setting an out of context parameter of the first device to true, wherein the second data frame is received when the out of context parameter is set to true, and wherein the out of context parameter complies with an Institute of Electrical and Electronics Engineers (IEEE) 802.11p standard.

18. The method of claim 16, wherein the second data frame further comprises a third address field that includes a basic service set identifier (BSSID) value, wherein the third address field comprises an address 3 field of a public action frame that complies with an Institute of Electrical and Electronics Engineers (IEEE) 802.11 standard, and further comprising identifying the BSSID value of the second data frame.

19. An apparatus comprising:
means for generating a data frame including an address field and a data field, wherein the address field includes a particular value indicating that the data field includes positioning information related to a location of a first device; and
means for transmitting the data frame to a second device.

20. The apparatus of claim 19, further comprising:
means receiving a second data frame including a second address field and a second data field from a third device, wherein the second address field includes a second particular value indicating that the second data field includes second positioning information related to a second location of the third device; and
means for processing the second positioning information based on the second particular value.
